(19) United States
(12) Patent Application Publication
(10) Pub. No.: US 2004/0081730 A1
(43) Pub. Date: Apr. 29, 2004

(54) Rapid continuous, and selective moisture content equalization of nuts, grains, and similar commodities

(76) Inventors: J Michael Drozd, Raleigh, NC (US); Timothy H Sanders, Raleigh, NC (US); Josip Simunovic, Raleigh, NC (US); Kenneth R Swartzel, Raleigh, NC (US); Keith Hendrix, Raleigh, NC (US)

Correspondence Address: BURNS DOANE SWECKER & MATHIS L L P, POST OFFICE BOX 1404, ALEXANDRIA, VA, 22313-1404, US

(21) Appl. No.: 10/333,584

(22) PCT Filed: Jul. 25, 2001
(86) PCT No.: PCT/US01/23305

(51) Int. Cl. A23L 3/00

(52) U.S. Cl. 426/241

(57) ABSTRACT

A microwave exposure chamber is used to process an agricultural commodity. A microwave waveguide connects a microwave source to an exposure region. Sensors measure temperature characteristics of the agricultural commodity as it passes through and exits the exposure region. Heat delivery is controlled by increasing or decreasing the power level of the microwave source and by increasing or decreasing the speed at which the agricultural commodity passes through the exposure region. The microwave exposure chamber removes moisture at a higher rate from high moisture portions of the commodity so as to equalize the moisture content and improve the processing and storage characteristics of the commodity. Also, a method of separating the skin of an agricultural commodity from the agricultural commodity is done by varying temperature through the use of microwave power and the length of electromagnetic exposure time.

### TECHNICAL FIELD

This invention relates to electromagnetic energy, and more particularly, to rapid, continuous, and selective moisture content equalization and/or skin separation of nuts, grains, and similar commodities.

### BACKGROUND ART

Moisture content is one of the key properties of peanuts, almonds, walnuts, hazelnuts, pecans, cashews, grains, herbs, spices, and other agricultural commodities. Moisture content very often determines (1) the commodity's quality grade, (2) how the commodity is or is not processed, and/or (3) how susceptible the commodity is to bacterial, fungal, or chemical spoilage. Moisture content reduction is conventionally implemented in various stages of storage, processing, and distribution via natural or forced drying. The current methods and approaches to industrial scale drying of these materials generally yield a wide range of final moisture contents that depend on, for example, the material source, the moisture reduction technique, and/or the time, location, and temperature of the treatment, transport, or storage. These variations can adversely affect the desired commodity and final product characteristics and should be minimized. There is a need for an industrially applicable method for moisture content equalization of previously treated commodities in order to minimize these variations and the resulting negative effects.

For example, peanut kernels are conventionally roasted in continuous convection roaster ovens. The quality and uniformity of input material affects the resulting quality and stability of the roasted product. Kernels with a higher than desired content of moisture will require more heat to achieve the roasting temperature due to the need for water removal and cooling of the kernels effected by evaporation. These kernels are therefore likely to be under-roasted and of inferior organoleptic quality and storage stability. The non-uniformities in moisture content can also cause a wider range of temperatures of kernels during and after the roasting process. Localized higher than desired moisture contents can also cause product spoilage through increased oxidation, molding, bacterial activity, and native enzymatic activity.

### DISCLOSURE OF THE INVENTION

These and other drawbacks, problems, and limitations of the prior art are overcome by using a microwave exposure chamber to process the agricultural commodity. A microwave waveguide connects a microwave source to an exposure region. Sensors measure temperature characteristics of the agricultural commodity as it passes through and exits the exposure region. Heat delivery is controlled by increasing or decreasing the power level of the microwave source and by increasing or decreasing the speed at which the agricultural commodity passes through the exposure region. The microwave exposure chamber removes moisture at a higher rate from high moisture portions of the commodity so as to equalize the moisture content and improve the processing and storage characteristics of the commodity.

### BRIEF DESCRIPTION OF THE DRAWINGS

The foregoing, and other objects, features, and advantages of the invention will be more readily understood upon reading the following detailed description in conjunction with the drawings in which:

FIG. 1 is an illustration of a microwave exposure chamber for processing an agricultural commodity;

FIG. 2 is an in-process infrared image obtained by sensing through the perforated metal waveguide;

FIG. 3 is a typical exit infrared image for high-moisture content peanut kernels;

FIGS. 4a and 4b is a typical exit infrared image and thermal image analyses for high-moisture content peanut kernels;

FIGS. 5a and 5b is a typical exit infrared image and thermal image analyses for medium-moisture content peanut kernels;

FIGS. 6a and 6b is a typical exit infrared image and thermal image analyses for low-moisture content peanut kernels; and

FIG. 7 is a graphic representation of temperature characteristics (means, medians, modes, minima and maxima) for peanut kernels with various moisture contents.

FIG. 8 is an illustration of the minimum, maximum and average temperature of an agricultural commodity after being exposed to an electromagnetic commodity.

FIG. 9 is an illustration of the minimum, maximum and average temperature of an agricultural commodity with an outer skin after being exposed to an electromagnetic commodity.

### BEST MODE/MODE(S) FOR CARRYING OUT THE INVENTION

In the following description, specific details are discussed in order to provide a better understanding of the invention. However, it will be apparent to those skilled in the art that the invention can be practiced in other embodiments that depart from these specific details. In other instances, detailed descriptions of well-known methods and circuits are omitted so as to not obscure the description of the invention with unnecessary detail.

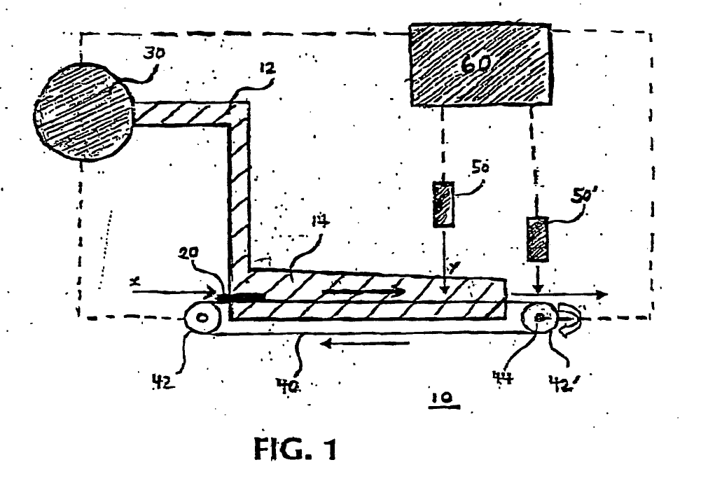

Referring now to the drawings, FIG. 1 illustrates a microwave exposure chamber for processing an agricultural commodity. Microwave exposure chamber 10 comprises a microwave waveguide 12 and an exposure region 14. Microwave waveguide 12 connects exposure region 14 to microwave source 30. A conveyor belt 40 passes around roller 42 to convey agricultural commodity 20 in direction x through exposure region 14. A second roller 42′ is driven by motor 44. Sensors 50 and 50′ are able to measure temperature characteristics of agricultural commodity 20. Sensors 50 and 50′ are connected to a control circuit 60. The control circuit 60 is connected to the microwave source 30 and the motor 44. Using microwave exposure chamber 10, it is possible to achieve rapid and selective moisture equalization of agricultural commodity 20.

Heat delivery can be controlled by, for example, increasing or decreasing the power level of the microwave generator 30 and by increasing or decreasing the speed of motor 44. Target temperature control is achieved via feedback from one or more remotely-sensing infrared sensing thermometers, infrared line sensors, or infrared cameras 50 and/or 50=. While FIG. 1 illustrates sensor 50 above exposure region 14 and sensor 50′ adjacent the exit of exposure region 14, it will be appreciated by those skilled in the art that the location, number, and type of sensors can be varied.

In a preferred embodiment, microwave exposure chamber 10 is used to equalize the moisture content of peanut kernels 20 prior to roasting. Microwave exposure chamber 10 is built to accommodate the dimensions of a peanut kernel roaster (not shown). Microwave energy delivered to the conveyerized kernels 20 will be absorbed preferentially by the seeds with higher moisture content, thus raising their temperature more than the seeds with lower moisture content. Depending on the delivered power level, this results in the drying effect and moisture content equalization through higher moisture content reduction for seeds with higher moisture contents. The overall mass of kernels 20 is concurrently preheated prior to further treatment, thus reducing the time and energy required for the roasting process. Uniformly pre-heated individual kernels 20 are also expected to yield a more uniformly roasted product due to a lowered temperature difference between kernel surface and center.

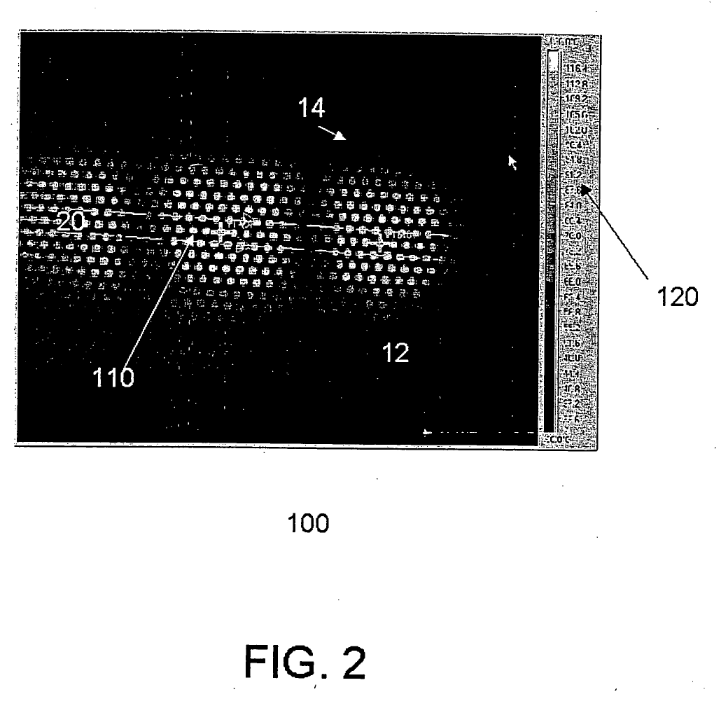

FIG. 2 is an in-process infrared image 100 obtained by sensing through the perforated metal waveguide 12. The agricultural commodity 20 is being passed through said perforated metal waveguide 12 and is being exposed to electromagnetic energy (not shown) in the exposure region 14. Thus, the agricultural commodity 20 is being heated and the temperature 110 can be monitored. A temperature scale 120 is also shown in this figure. This is important information because rather than monitoring the temperature 110 of the commodity 20 outside of the exposure region 14, one can monitor the heating process that takes place in the exposure region 14. This could be a more accurate way of measuring the temperature 110 because it is a real time measurement.

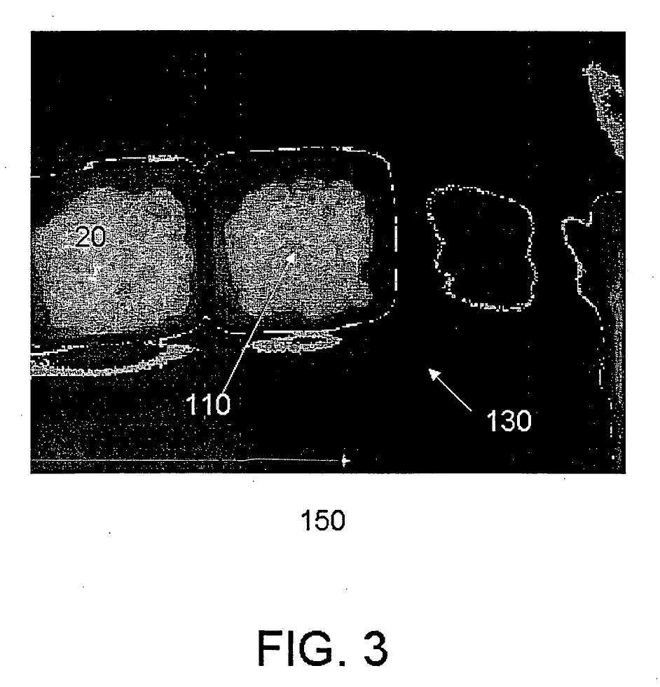

FIG. 3 is typical exit infrared image 150 for high-moisture content peanut kernels. As, the agricultural commodity 20 exits the exposure region on a conveyor belt 130, an infrared image of the temperature 110 of said commodity 20 is taken. This allows for monitoring of the temperature 110 of the commodity 20 for feedback back to the microwave source. If the temperature is too low or high, either the speed of the belt 130 or the amount of microwave power into the exposure region can be varied. An infrared image 150 shows that there is some variation in temperature, but more likely indicates where there was initially higher moisture content. Higher initial moisture content allows for higher microwave power coupling, and thus, a higher temperature 110. Although, the moisture at the exit of the exposure region is gone, this increased temperature transfers to the commodity 20 temporarily. Thus, a relative uniformity is created by selectively removing higher moisture content from the high-moisture commodities while removing less from the lower moisture commodities.

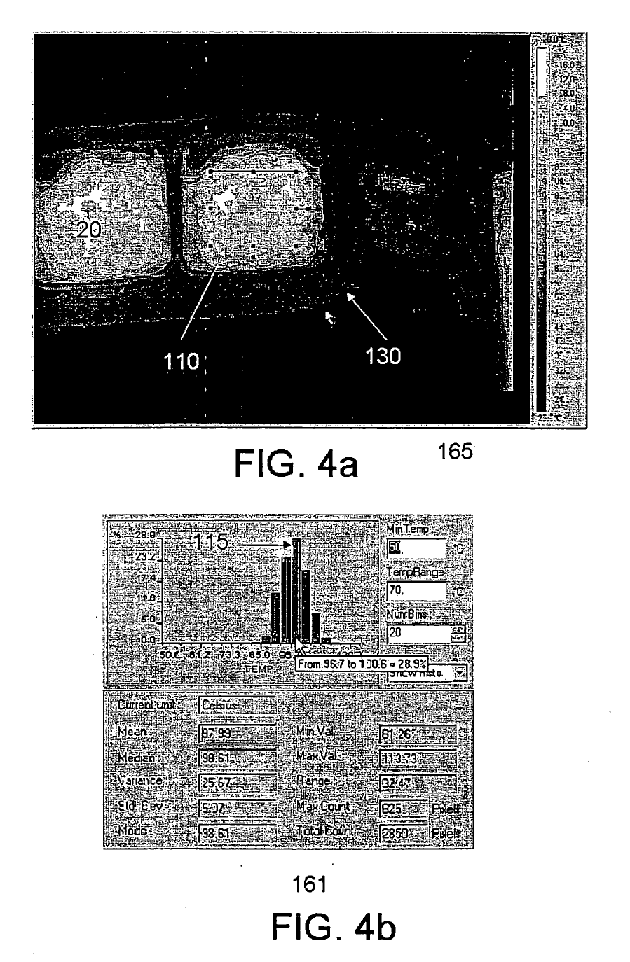

FIGS. 4a and 4b is a typical exit infrared image 165 and thermal image analyses 161 for high-moisture content peanut kernels, respectively. This is a specific example of an agricultural commodity 20. The infrared image 165 shows the agricultural commodity 20 exiting the exposure region on the conveyor belt 130. A plurality of temperatures is read and a histogram of the temperatures is shown. For specific temperature ranges on the x axis, the percentage of the sample that falls into that temperature range is shown on the y axis. For example, at a certain temperature range 115, 96.7 to 100.6 degrees Celsius, the amount of the sample, which is in that temperature range is 28.9%, the highest percentage.

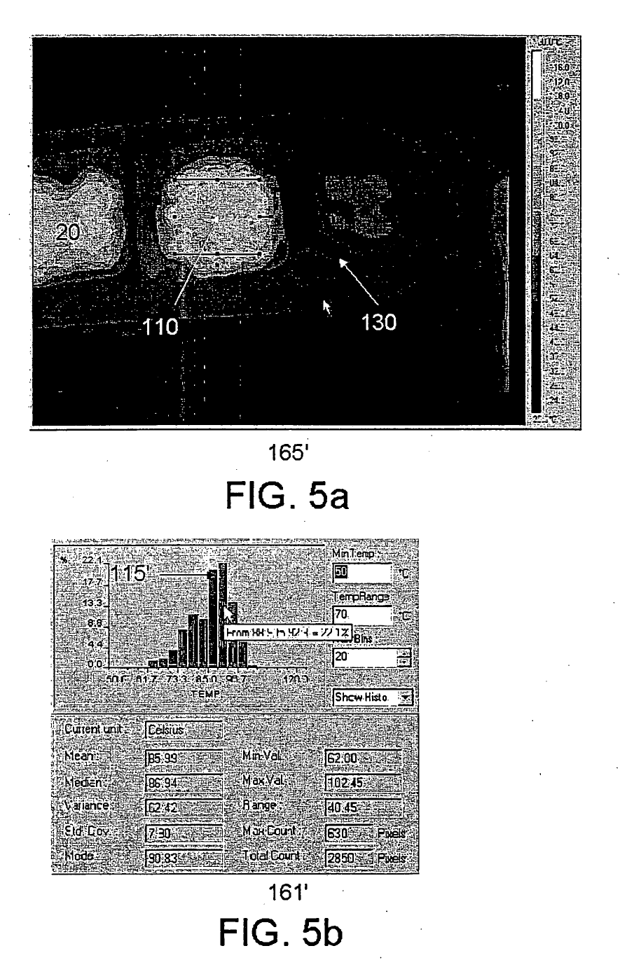

FIGS. 5a and 5b is a typical exit infrared image 165′ and thermal image analyses 161′ for medium-moisture content peanut kernels, respectively. The infrared image 165′ shows the agricultural commodity 20 exiting the exposure region on the conveyor belt 130. The same microwave power and belt speed was used as was done in the experiment mentioned in FIG. 4. A plurality of temperatures is read and a histogram of the temperatures is shown. For this specific example of medium-moisture peanuts, at a certain temperature range 115′, 88.9 to 92.8 degrees Celsius, the amount of the sample, which is in that temperature range is 22.1%, again, the highest percentage of the sample. Thus, with all variables kept constant from the previous experiment except for the moisture content in the peanuts, the temperature of the peanuts decreased from a range of 96.7-100.6 to 88.9-92.8 degrees Celsius. This shows that the moisture content allows for higher coupling.

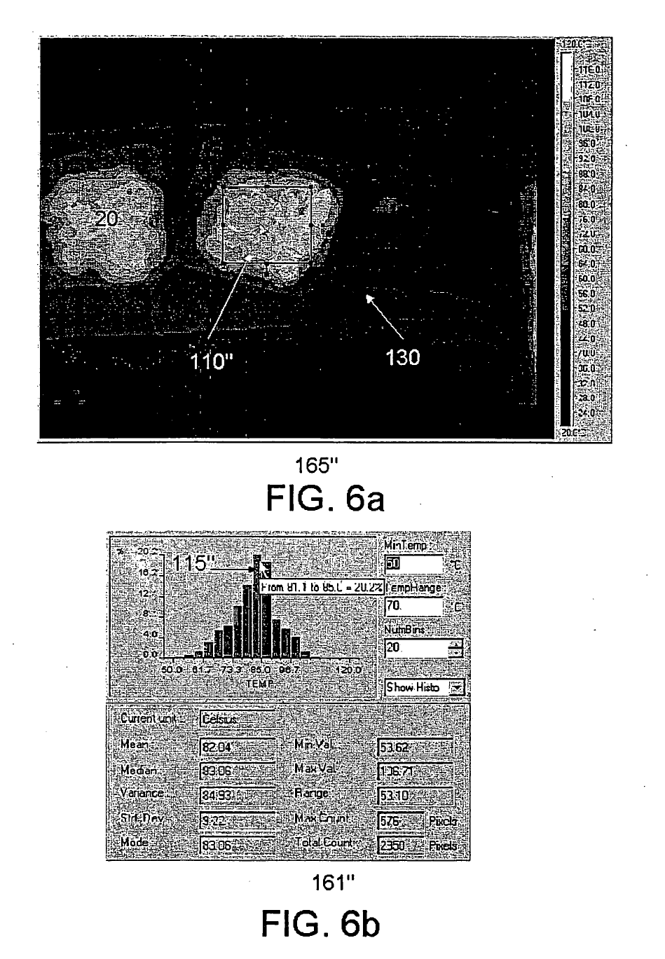

FIGS. 6a and 6b is typical exit infrared image 165″ and thermal image analyses 161″ for medium-moisture content peanut kernels, respectively. The infrared image 165″ shows the agricultural commodity 20 exiting the exposure region on the conveyor belt 130. Again, the same microwave power and belt speed was used as was done in the experiment mentioned in FIG. 4 and FIG. 5. A plurality of temperatures is read and a histogram of the temperatures is shown. For this specific example of low-moisture peanuts, at a certain temperature range 115″, 81.0 to 85.0 degrees Celsius, the amount of the sample, which is in that temperature range is 20.2%, the highest percentage in this histogram. Thus, even a lower temperature is achieved with all variables kept constant from the previous experiments except for the moisture content in the peanuts 20. This further shows that the lower the moisture content, the less the temperature will be given a constant microwave power and exposure time. This is advantageous for non-homogeneous moisture content peanuts 20 because the moisture removal will be higher with a higher temperature with the high moisture kernels as compared with a lower temperature for the low moisture kernels. Thus, relative moisture equilibrium will be strived for through this selective coupling creating a relative uniformity among peanuts. This not only would apply for peanuts, but for all agricultural commodities.

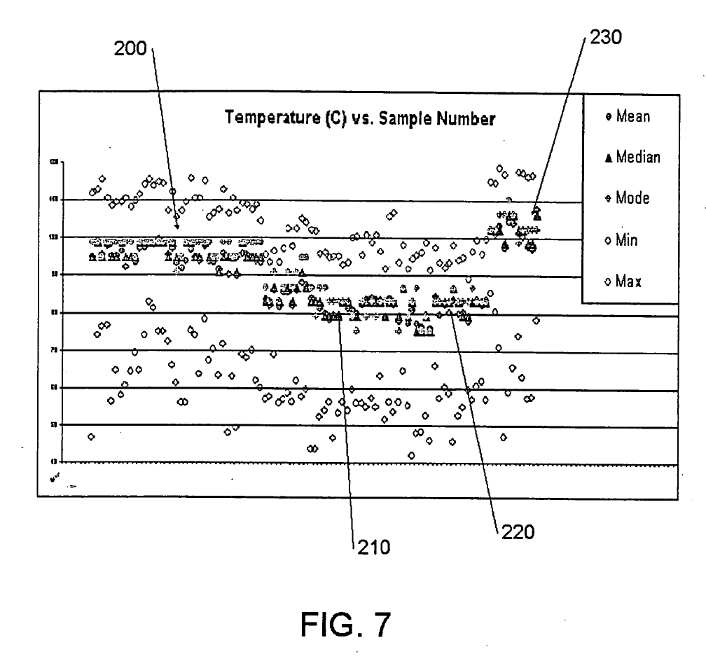

FIG. 7. is a graphic representation of temperature characteristics (means, medians, modes, minima and maxima) for peanut kernels with various moisture contents. As can be seen, with moisture content as a variable, the temperature of the peanut kernels changes also. The higher the moisture content, with the same exposure time and the same amount of power, the higher the temperature of the peanut kernel. This is important to notice as coupling to the higher moisture kernels is easier to achieve as opposed to the lower moisture kernels. The high-moisture kernels 200 achieved the highest median temperature. The medium-moisture kernels 210 had a lower temperature, but the low-moisture kernels 200 achieved the lowest temperature. However, when power was increased for the low-moisture kernels in a separate experiment, the temperature rose. This is shown in the data 230. This shows that power could be a variable in coupling microwave energy to the commodity. Another variable is microwave exposure time although there is an optimum compromise between power and exposure time. If the commodity gets too hot too fast, the quality will be not be as good as a kernel with longer exposure time and less power so it is at a lower temperature.

As illustrated by FIGS. 2-7, it is possible to continuously, rapidly, and selectively equalize the moisture content variations in nuts, grains and similar agricultural material. Higher moisture content removal rates are achieved for segments of material with higher moisture contents; resulting in more uniform characteristics and minimized overheating of material segments with lower moisture content. Additional functional characteristics and benefits can be achieved using the invention, such as blanching and preheating of material in preparation for further processing.

Microwave exposure chamber 10 (FIG. 1) solves the problem of uneven moisture content of agricultural materials such as nuts, grains, etc. by continuous, rapid and selective removal of moisture at increased rate for the material segment with higher moisture content, resulting in a more uniform material with improved processing and storage characteristics.

Presently, most peanut kernels are dried in batch mode. Microwave exposure chamber 10 provides a continuous process. The rate of moisture removal is increased by rapid volumetric heating as opposed to the conventional heating via conduction, convection, and radiation which in all cases require extended periods of time for the heat to penetrate the material and for moisture to permeate through the individual product units (nuts, kernels or grains). The selectivity of the process refers to the coupling of the energy to the moisture contained in the material—effectively resulting in increased rate of heating (higher treatment and exit temperatures) for those segments of material containing undesirably high moisture levels. Conversely, those material segments that contain lower moisture amounts heat at a lower rate resulting in lower final temperature and lower rate of moisture removal. With any of the conventional alternatives, the temperature distribution is inverse to the moisture content distribution—the segments of the material that are drier end up having the higher process and exit temperature than those with higher moisture content. Microwave exposure chamber 10, however, has the capability to remove excessive moisture by selectively heating the targeted material components/segments without overheating and unnecessary energy expense for those segments that already have the desired reduced levels of moisture content. Additional unique benefit of microwave exposure chamber 10 is the increased energy density level delivery per unit volume, mass and time compared to the conventional means of moisture reduction treatments.

Additionally, the invention could be used for pre-roast equalization of moisture content in coffee beans. Other similar granular and particular materials could be treated with the comparable beneficial results—such as cattle feed, pet foods, fertilizers etc.

In addition to the described and documented application for the treatment of peanuts, other nuts, grains, herbs, spices, agricultural and bio-materials with varying particular and granular structure could be processed. Additionally, for the processing of skins-on peanut kernels, the process has the concurrent benefits of enhancing the kernel blanching—i.e. the removal of skins.

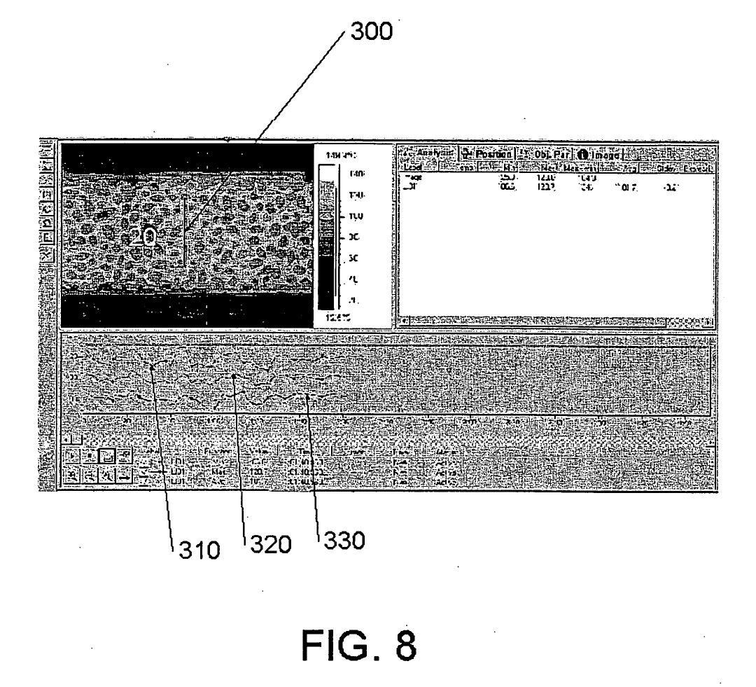

FIG. 8 illustrates a continuous line of agricultural commodity 20 after exposure to electromagnetic energy and an analysis of minimum 330, maximum 320 and average temperature of said commodity 310. The temperature 310, 320 or 330, taken from a line 300 across the material, was held relatively steady as the material 20 was passed through the thermal sensor. Thus, for a continuous line of agricultural commodity 20 exposed to electromagnetic energy, the temperature 310, 320 or 330 is held relatively constant. This uniformity allows for an end product where the agricultural commodity contains a consistent amount of moisture.

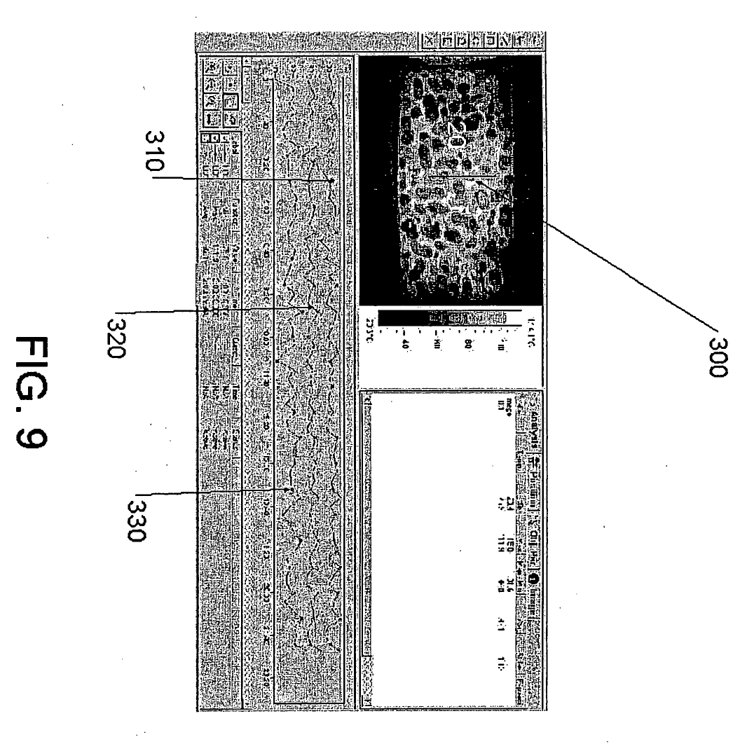

FIG. 9 illustrates a continuous line of agricultural commodity 20′ with skin after exposure to electromagnetic energy and an analysis of minimum 330, maximum 320 and average 310 temperature of said commodity 20′. This shows that there is not much variance between agricultural commodity with 20′ and without skin 20 for electromagnetic exposure. This is important for not only heating agricultural commodity 20 and 20′ but also it is also a method of separating the skin from the agricultural commodity 20′. This method of separating a skin layer from the core of an agricultural commodity 20′ comprises the steps of generating microwave energy into an exposure region and passing an agricultural commodity 20′ with a skin through said microwave energy. Next, there is sensing of at least one temperature characteristic 310, 320 or 330, taken from a line 300 across the material, of the agricultural commodity 20′. Once the temperature data, it is fed back to a control system, which will control the temperature of the agricultural commodity and electromagnetic exposure time based upon the separation of the skin of the agricultural commodity and the agricultural commodity. If the temperature of the agricultural commodity received by the sensor is lower than the desired temperature, the control system outputs to tell the microwave source to increase power and vice versa. This maintains the commodity at a set temperature that can be set by the operator. Once the desired temperature is maintained, the skin will release from the commodity. This is a valuable process because it enhances the quality of the agricultural commodity, while reducing the time and energy required to blanch raw agricultural commodities as well as the ability to remove moisture to a given amount.

While the foregoing description makes reference to particular illustrative embodiments, these examples should not be construed as limitations. Thus, the present invention is not limited to the disclosed embodiments, but is to be accorded the widest scope consistent with the claims below.

1. A method for reducing the moisture content of an agricultural commodity, the method comprising the steps of:
generating microwave energy into an exposure region;
passing an agricultural commodity through said microwave energy;
sensing at least one temperature characteristic of the agricultural commodity; and
controlling the moisture content based upon the at least one temperature characteristic.

2. A method as described in claim 1, the method further comprising the step of controlling the microwave based upon the at least one temperature characteristic.

3. A method as described in claim 1, the method further comprising the step of controlling the rate at which the agricultural commodity is passed through the microwave based upon the at least one temperature characteristic.

4. A method of separating a skin layer from the core of an agricultural commodity, the method comprising the steps of:
generating microwave energy into an exposure region;
passing an agricultural commodity with a skin through said microwave energy;
sensing at least one temperature characteristic of the agricultural commodity; and
controlling the temperature of the agricultural commodity and electromagnetic exposure time based upon the separation of the skin of the agricultural commodity and the agricultural commodity itself.

5. A method as described in claim 4, the method further comprising the step of controlling the microwave power based upon the at least one temperature characteristic.

6. A method as described in claim 4, the method further compromising the step of controlling the electromagnetic energy exposure time by varying the conveyor belt speed.
